(19) United States
(12) Patent Application Publication
(10) Pub. No.: US 2026/0149223 A1
(43) Pub. Date: May 28, 2026

(54) SELF-ALIGNING CONNECTOR SYSTEM

(71) Applicant: DISH Network L.L.C., Englewood, CO (US)

(72) Inventor: Joel Cardoso Miranda, El Paso, TX (US)

(21) Appl. No.: 18/957,451

(22) Filed: Nov. 22, 2024

(51) Int. Cl. H01R 13/631; H01R 43/26

(52) U.S. Cl. CPC H01R 13/6315; H01R 43/26

(57) ABSTRACT

The present technology is generally directed to a connector system and a method of using thereof. In various embodiments, the connector system includes: a housing enclosure having a first wall and a second wall, the first wall having a first opening, the second wall having a second opening; and a plurality of mounting blocks movably supported within an interior of the housing enclosure, the plurality of mounting blocks being independently movable relative to each other, and each of the plurality of mounting blocks being configured to receive, via the first opening, a cable with a connector. The connector system is configured to operably connect, via the second opening, the respective cables to a device that has a set of ports configured to receive connectors of the respective cables.

### TECHNICAL FIELD

The present technology is directed to connector systems and methods.

### BACKGROUND

Devices such as TV receiver boxes often come equipped with multiple ports to meet the varied connectivity needs of consumers in today's digital age. With home entertainment systems incorporating a wide range of peripherals such as gaming consoles, streaming devices, and sound systems, the inclusion of multiple ports ensures compatibility and flexibility.

### SUMMARY

An aspect of the present disclosure relates to a connector system. The connector system may include a housing enclosure having a first wall and a second wall, the first wall having a first opening, the second wall having a second opening; and a plurality of mounting blocks movably supported at least partially within an interior of the housing enclosure, the plurality of mounting blocks being independently movable relative to each other, in which each of the plurality of mounting blocks is configured to receive, via the first opening, a cable with a connector, the connector system is configured to operably connect, via the second opening, the respective cables to a device that has a set of ports configured to receive connectors of the respective cables.

Another aspect of the present disclosure relates to a method of using a connector system. The method may include connecting a plurality of cables to a connector system of any one or more of the solutions disclosed herein; and connecting the connector system with a device that has a set of ports such that each of the set of ports receives one of the plurality of cables.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present disclosure.

FIG. 1 shows an illustrative testing system in accordance with one or more embodiments.

FIGS. 2A and 2B illustrate various subject devices with different port configurations that can be used with a connector system in accordance with one or more embodiments.

FIG. 3 shows an illustrative port configuration of a subject device that can be used with a connector system in accordance with one or more embodiments.

FIGS. 4 and 5 show perspective and top views of a connector system in accordance with one or more embodiments.

FIG. 6 shows a perspective view of a plurality of illustrative mounting blocks within a connector system in accordance with one or more embodiments.

FIGS. 7 and 8 shows a front view and a top view of a connector system with an outer housing removed to expose the components within the housing of a connector system in accordance with one or more embodiments.

FIG. 9 is a flowchart for a process of using a connector system in accordance with some embodiments of the present disclosure.

### DETAILED DESCRIPTION

Aspects of the present disclosure relate to a connector system and method of using thereof. In some embodiments, the connector system may include a housing enclosure having a first wall and a second wall, the first wall having a first opening and a second opening; and a plurality of mounting blocks movably supported within an interior of the housing enclosure, the plurality of mounting blocks being independently movable relative to each other, and each of the plurality of mounting blocks being configured to receive, via the first opening, a cable with a connector. The connector system may be configured to operably connect, via the second opening, the respective cables to a device that has a set of ports configured to receive connectors of the respective cables.

The connector system as disclosed herein may be used to conveniently connect respective subject devices having multiple ports to another device (e.g., a test device, a smart television, a home entertainment system) using multiple cables (e.g., via connectors on the cables) plugged into the ports of each of the respective subject devices. Example subject devices may include TV receiver boxes, internet connection devices, streaming media players, routers, portable Wi-Fi hotspots, computer (including, e.g., laptop) docking stations, mini personal computers (PCs), gaming consoles, smart home hubs, network switches, USB hubs and docking stations, etc. Merely by way of example with reference to a home entertainment system, a subject device (e.g., a display) may include or be connectable to one or more of a wide range of peripherals such as gaming consoles, streaming devices, and sound systems.

The multiple ports available on a subject device may enhance its versatility, allowing different devices to be connected or disconnected as desired. This ease of connection or disconnection is advantageous when such connection and disconnection operations need to be performed frequently. For instance, during quality assurance (QA) stages or functional testing phases for subject devices with multiple ports, connecting these ports to a test device can consume a significant portion of the cycle time per unit. By incorporating a self-aligning connector system into these processes, companies can substantially improve their efficiency and productivity. This technology may not only accelerate the connection of cables to subject devices but also reduce time-related costs associated with traditional methods. Consequently, the overall cost per unit may decrease, benefiting both consumers and companies financially. The connector self-aligning system may offer a practical solution for optimizing operations and promoting cost-effectiveness across various industries.

The connector system may be configured to link various subject devices to a test device, accommodating differences in the port configurations of the subject devices. The connector system may cater to the diversity in port types and/or arrangements across different subject devices. The connector system may include a plethora of mounting blocks that are configured to be movable independently relatively to each other within the connector system to self-align and accommodate positional deviations in the ports of various subject devices. This ensures a seamless and adaptable connection between each subject device and the test device. The tolerance to slight positional deviations in port arrangements may also make the connector system adaptable to design changes or variations in subject devices. This flexibility is valuable in environments where devices are frequently updated or modified.

A mounting block of the connector system may be configured with a replaceable adaptor, specifically tailored to securely hold a cable (e.g., a connector of the cable) in place. This feature may further enhance the system's adaptability and ease of use. If there's a need to accommodate a different type of cable by a specific mounting block, the solution is straightforward: simply swap out the existing adaptor with one that's compatible with the new cable. For example, while subject device(s) A may feature ports A, B, C, and D aligned from left to right, subject device(s) B may have the same ports but in a different sequence: B, D, A, and C aligned along the same direction as subject device A (e.g., from left to right in its operation orientation). As another example, while subject device(s) A may feature ports A, B, C, and D aligned from left to right, subject device(s) B may have ports A, C, and E. The connector system may cater to the diversity in port types and arrangements across such different subject devices by allowing flexible configuration of the mounting blocks using replaceable adaptors. Accordingly, this connector system can be used with a wide range of devices, reducing the need for multiple, device-specific connector systems.

A plethora of respective mounting blocks within the connector system may be designed to firmly hold cables (e.g., the connectors of such cables), enabling multiple cables to be simultaneously connected to or disconnected from multiple ports of a sample device through a single plug-in or unplug action, eliminating a cumbersome process of individually connecting or removing cables for each port, and therefore may significantly reduce setup time and increase efficiency in various environments such as, e.g., testing, etc. In addition, the connection system, by simplifying the connection operation, can reduce the likelihood of connection errors, leading to more accurate and reliable connection.

The connector system's ability to adapt to different devices makes it scalable, suitable for both small-scale operations (e.g., personal uses) and large-scale operations (e.g., testing in manufacturers'environments). As new devices with different port configurations are developed, this connector system can potentially accommodate them without the need for significant redesign, making it a future-proof or future-friendly solution.

Furthermore, the cables from the mounting blocks are connected to the test device. The side of the testing system connected to the test device remains stationary and does not need adjustments or manipulations when swapping different subject devices. The connector system may significantly reduce the need for repeated physical manipulation or repositioning of the test device for each new connection. This reduction in mechanical wear and tear may maintain the integrity and longevity of the test device, thereby not only extending the operational life of the test device but also ensuring consistent performance and reliability in testing outcomes.

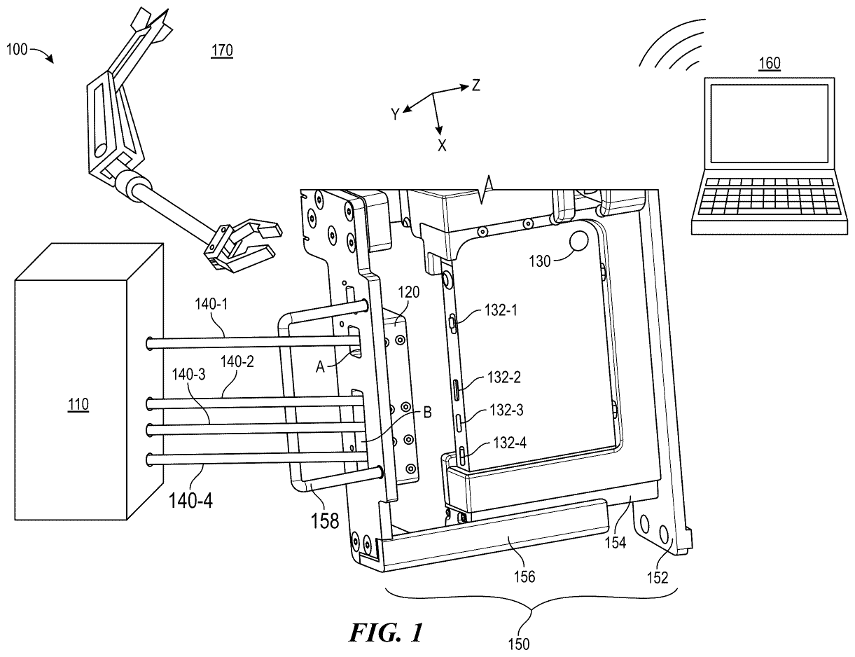

Specific details of several embodiments of the present technology are described herein with reference to FIGS. 1-9. The present technology, however, can be practiced without some of these specific details. In some instances, well-known structures and techniques often associated watersport boards, and the like, have not been shown in detail so as not to obscure the present technology. The terminology used in the description presented below is intended to be interpreted in its broadest reasonable manner, even though it is being used in conjunction with a detailed description of certain specific embodiments of the disclosure. Certain terms can even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements can be arbitrarily enlarged to improve legibility. Component details can be abstracted in the Figures to exclude details such as position of components and certain precise connections between such components when such details are unnecessary for a complete understanding of how to make and use the present technology. Many of the details, dimensions, angles, and other features shown in the Figures are merely illustrative of particular embodiments of the disclosure. Accordingly, other embodiments can have other details, dimensions, angles, and features without departing from the spirit or scope of the present technology.

For illustrative purposes, a coordinate system is provided in FIGS. 1-8, in which an X-axis extends along a transverse axis or width direction of a connector system 120, a Y-axis is orthogonal to the X-axis and extends along a depth direction of the connector system 120, and a Z-axis extends orthogonal to the X-and Y-axes along the direction the connector system 120 moves to or away from a subject device 130.

FIG. 1 shows illustrative testing system using a connector system in accordance with one or more embodiments. An exemplary testing system 100 may include a test device 110 configured to test a subject device 130 and a connector system 120 configured to operably connect the subject device 130 to the test device 110. The subject device 130 may have four ports 132 (individually identified as a first port 132-1, a second port 132-2, a third port 132-3, and a fourth port 132-4) and are connected to cables 140 (individually identified as a first cable 140-1, a second cable 140-2, a third cable 140-3, and a fourth cable 140-4), respectively, via the connector system 120. The connector system 120 and the subject device 130 may be mounted on a mounting system 150. The testing system 100 may include a control system 160 and/or a robotic arm 170 configured to perform one or more operations.

The test device 110 may be configured to test the subject device 130. Merely by way of example, the subject device 130 is a TV receiver. The test device 110 may be configured to test the functionality, signal reception and quality, audio and video output, connectivity, power consumption, or the like, or a combination thereof. The test device 110 may be configured to perform a multi-faceted test when operably connected to the subject device 130 via the connector system 120 and the multiple cables 140.

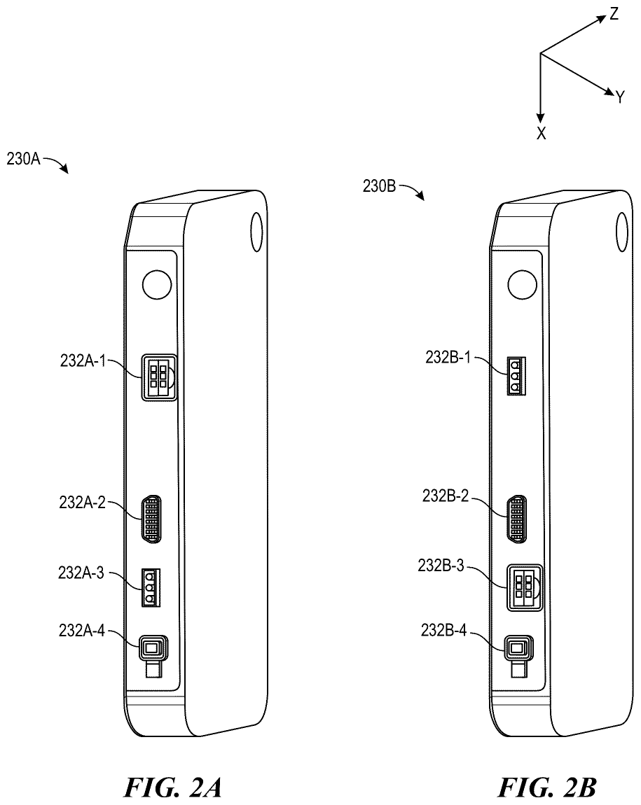

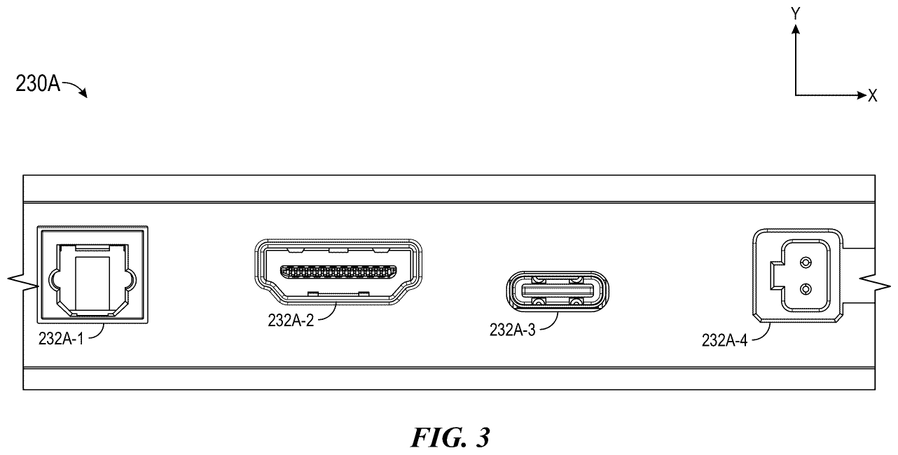

The test device 110 may be configured to test various subject devise 130. FIGS. 2A and 2B show illustrative devices 230A and 230B with different port configurations that can be used with the connector system 120 in accordance with one or more embodiments. The device 230A illustrated in FIG. 2A has four ports 232A, including an ethernet port 232A-1, a high-definition multimedia interface (HMDI) port 232A-2, a universal serial bus (USB) port 232A-3, and a power input port 232A-4, arranged from the top to the bottom of the device 230A positioned as illustrated in FIG. 2A. FIG. 3 is an enlarged view of a portion of the device 230A showing the four ports 232. The device 230B illustrated in FIG. 2B also has four ports 232B, including a USB port 232B-1, an HMDI port 232B-2, an ethernet port 232B-3, and a power input port 232B-4, arranged from the top to the bottom of the device 230B positioned as illustrated in FIG. 2B.

The devices 230A and 230B have four ports of same types but arranged in different orders. Both devices 230A and 230B may be operably connected to the test device 110 via the connector system 120. For example, the mounting blocks of the connector system 120 may be configured to include adapters configured to secure cables (e.g., connectors of the cables) including a cable with an Ethernet connector, a cable with an HDMI connector, a cable with a USB connector, and a power cord, respectively, in a spatially corresponding manner with respect to the four ports 232A, so that these cables may be plugged into the four ports 232A of the device 230A simultaneously by a single plug-in action. As another example, the mounting blocks of the connector system 120 may be configured to include adapters configured to secure cables (e.g., connectors of the cables) including a cable with a USB connector, a cable with an HDMI connector, a cable with an Ethernet connector, and a power cord, respectively, in a spatially corresponding manner with respect to the four ports 232B, so that these cables may be plugged into four ports 232B of the device 230B simultaneously by a single plug-in action.

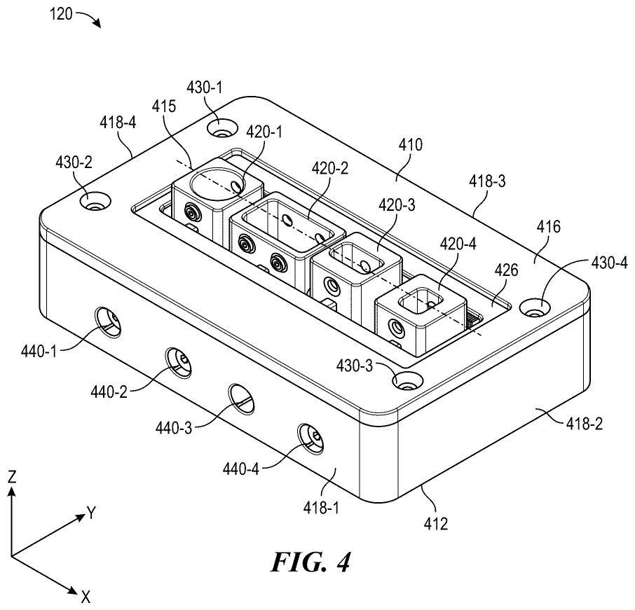

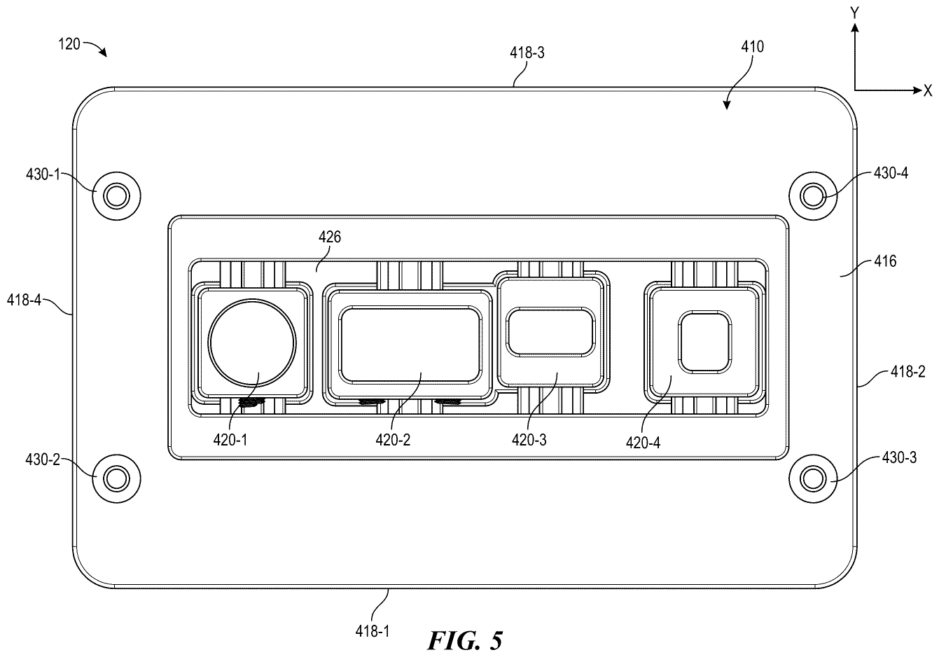

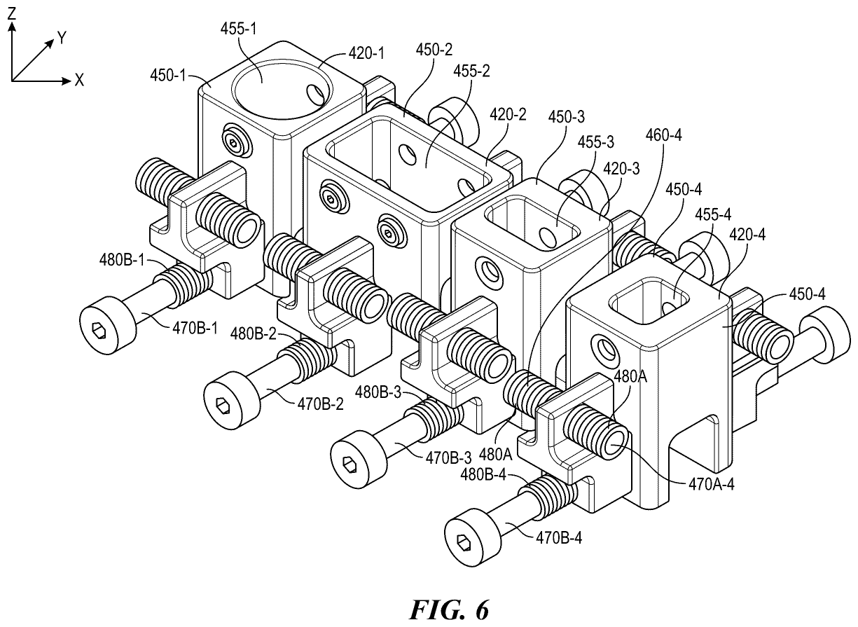

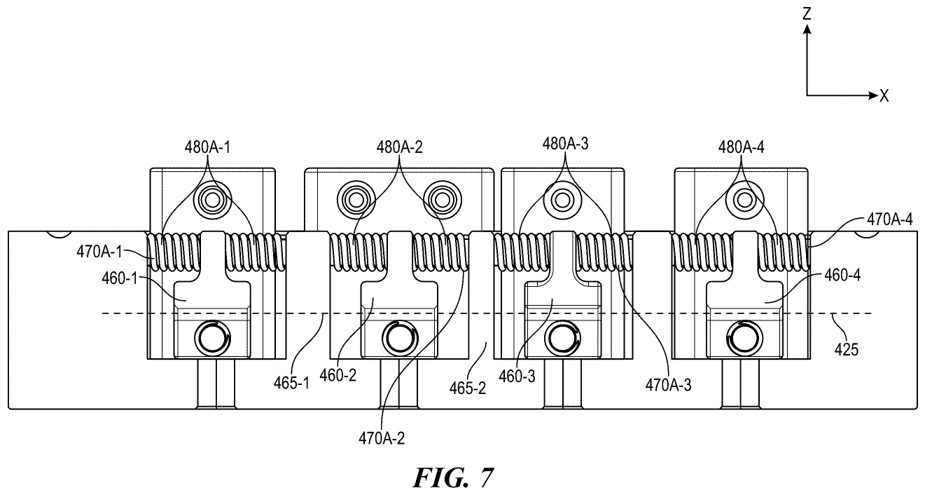

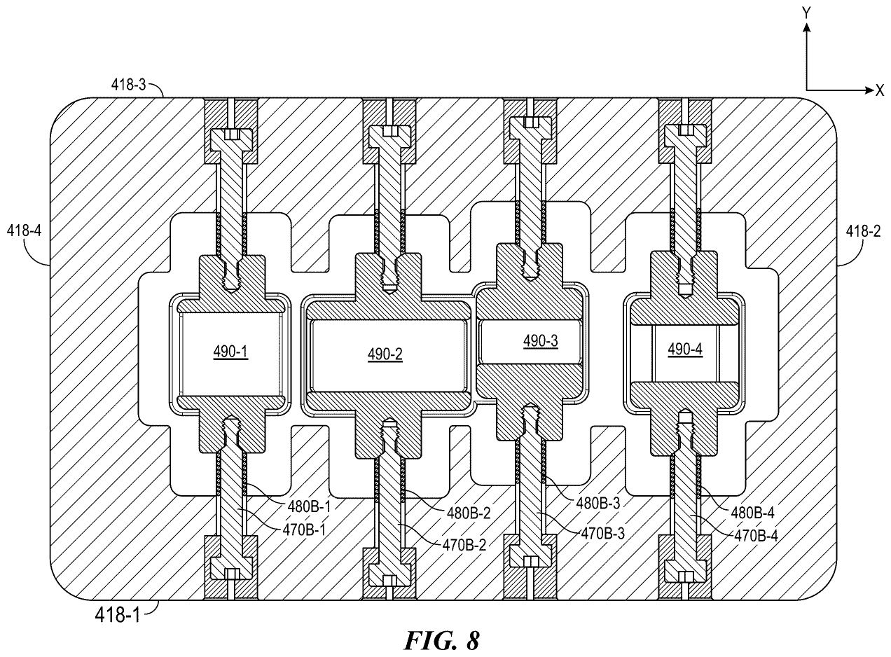

FIGS. 4 and 5 show perspective and top views of a connector system in accordance with one or more embodiments. A bottom view of the connector system may be similar to the top view as illustrated in FIG. 5. FIG. 6 shows a perspective view of a plurality of illustrative mounting blocks within a connector system in accordance with one or more embodiments. FIGS. 7 and 8 are a front view and a top view of a connector system with an outer housing (a housing enclosure 410) removed to expose the components within the housing of a connector system in accordance with one or more embodiments. FIG. 8 is viewed from a height along the Z-axis that is below the level 425 (as illustrated in FIG. 7).

The connector system 120 may include a housing enclosure 410 and a plurality of mounting blocks 420 (individually identified as a first mounting block 420-1, a second mounting block 420-2, a third mounting block 420-3, and a fourth mounting block 420-4) movably supported at least partially within an interior of the housing enclosure 410.

The housing enclosure 410 includes a first wall 412 and a second wall 416 that oppose each other. The first wall 412 may include a first opening 422. The second wall 416 may include a second opening 426. The mounting blocks 420 may be exposed to the exterior of the housing enclosure 410 via the first opening 422 and the second opening 426. The second opening 426 (facing the subject device 130 as illustrated in FIG. 1) may be continuous as illustrated in FIG. 5. The first opening 422 (facing the test device 110 in FIG. 1) may be continuous as illustrated in FIGS. 4 and 5. The first opening 422 may include a plurality of apertures. See, e.g., apertures A and B as illustrated in FIG. 1 collectively constituting the first opening 422. Similarly, the second opening 426 may include a plurality of apertures. The mounting blocks 420 may receive cables 140 via the first opening 422, and interface with the subject device 130 via the second opening 426. The first opening 422 and/or second opening 426 may be sized to allow a movement of the mounting blocks 420 along the X-axis and the Y-axis.

Merely by way of example, to connect the test device 110 with the subject device 130 via cables 140 and the connector system 120, the individual cables 140 may be connected to the test device 110 on one end, and the subject device 130 on another end via the connector system 120. The cables 140 (e.g., connector cords) may access the respective mounting blocks 420 of the connector system 120 via the first opening 422, and be connected to the mounting blocks 420. The respective connector terminals of the cables 140 (or the connector terminal of an adaptor receiving a cable 140, as described elsewhere in the present document) may access a set of ports of the subject device 130 via the second opening 426, and be connected to the set of ports of the subject device 130.

The first wall 412 and the second wall 416 may be connected to side walls 418 (individually identified as a first side wall 418-1, a second side wall 418-2, a third side wall 418-3, a fourth side wall 418-4). The first wall 412 and the second wall 416 may be attached to each other and/or the side walls 418 via connection mechanisms 430 (individually illustrated as a first connection mechanism 430-1, a second connection mechanism 430-2, a third connection mechanism 430-3, and a fourth connection mechanism 430-4). For example, the second wall 416 may include a hole to receive a screw that extends into a threaded hole located on a side wall 418 (e.g., the side wall 418 having a protrusion extending into the interior of the housing enclosure 410 and including such a threated hole to receive the screw) to form a connection between the second wall 416 and the side wall 418. As another example, the first wall 412 and/or the second wall 416 may be attached to each other and/or to the side walls 418 by adhesive (e.g., glue).

In some embodiments, the housing enclosure 420 may include multiple portions that are separable to allow access to the interior of the housing enclosure 420, so that one or more components (e.g., one or more mounting blocks) may be positioned in or removed from the interior of the housing enclosure 420. Either the first wall 412 or the second wall 416, or both, may be removably or integrally connected to one or more side walls 418 to form a first portion, while the other may be a second portion that is separable from the first portion. Alternatively, the first wall 412 and the second wall 416 may be connected via, e.g., one or more side walls 418, to form a first portion, while at least one or more side walls 418 may form a second portion that is separable from the first portion.

For instance, the housing enclosure 410 may include a base component (e.g., a first portion) and a retaining cover (e.g., a second portion). The base component may include a base plate. In some embodiments, the base plate may be removably or integrally connected to one or more side walls 418 extending away from the base plate. For example, the side wall(s) 418 may extend substantially perpendicularly from the base plate. The retaining cover may include a cover plate. In some embodiments, the cover plate may be removably or integrally connected to one or more side walls 418 extending away (e.g., substantially perpendicularly) from the cover plate. Merely by way of example, the base component may include a base plate and one or more side walls 418 along part of or the entire perimeter of the base plate as an integral piece, while the retaining cover may include a cover plate without side walls. The base component and the retaining cover may be removably connected to each other via one or more connection mechanisms including, for example, one or more screws, adhesive, or a snap connection. When connected, the base component and the retaining cover may form an interior of the housing enclosure 410 for housing the mounting block(s) 420.

The base plate of the base component may constitute the first wall 412 where the first opening 422 is located. The cover plate of the retainer cover may constitute the second wall 416 where the second opening 426 is located. In some embodiments, the configuration may be reversed: the base plate may constitute the second wall 416 where the second opening 426 is located, while the cover plate may constitute the first wall 412 where the first opening 422 is located.

An individual mounting block 420 may be symmetric with respect to a midplane 415 and therefore only a half of the mounting block 420 on one side of the midplane 415 is described. The mounting block 420 may include a casing 450 (individually identified as a first casing 450-1, a second casing 450-2, a third casing 450-3, a fourth casing 450-4). The mounting block 420 may include a support element 460 (individually identified as a first support element 460-1, a second support element 460-2, a third support element 460-3, and a fourth support element 460-4). The support element 460 may be an integral piece with the casing 450. For example, the support element 460 and the casing 450 may be produced by 3D printing. The support element 460 may be attached to the casing 450 by an attachment mechanism (e.g., a threaded connection using a screw, glue, etc.). The mounting block 420 may be supported by a plurality of rods coupled to the support element 460.

The plurality of rods may include a width rod 470A (individually identified as a first width rod 470A-1, a second width rod 470A-2, a third width rod 470A-3, and a fourth width rod 470A-4) and a depth rod 470B (individually identified as a first depth rod 470B-1, a second depth rod 470B-2, a third depth rod 470B-3, and a fourth depth rod 470B-4). The support element 460 may include a first portion where the width rod 470A is supported and a second portion where the depth rod 470B is supported. As illustrated in, e.g., FIG. 6, the first portion may have the shape of an upside-down T. The first portion and the second portion of the support element 460 may be an integral piece (e.g., produced by 3D printing) or separate pieces connected together (e.g., by glue).

A set of bias components 480 (including 480A and/or 480B as discussed below) may be configured on the width rod 470A and the depth rod 470B to allow a movement of the mounting block 420 along the X-axis, along the Y-axis, or along both the X-axis and the Y-axis. The set of bias components 480 (480A and/or 480B) may include one or more springs.

One or a pair of bias components 480A (individually identified as bias components or bias component pairs 480A-1, 480A-2, 480A-3, and 480A-4) may be positioned on the width rod 470A to allow a movement of the mounting block 420 along the X-axis. Merely by way of example, a pair of bias components 480A may be supported on the width rod 470A and positioned on the opposite sides of the vertical portion of the T shaped first portion of the support element 460. The width rod 470A may be further supported on the housing enclosure 410 (e.g., a protrusion 465 (individually identified as a first protrusion 465-1, a second protrusion 465-2, a third protrusion 465-3) extending into the interior of the housing enclosure 410 from a side wall 418 (e.g., the side wall 418-1 as illustrated). Accordingly, respective mounting blocks 420 may move along the X-axis on the width rod 470A independently to each other. The second opening 426 may be sized to allow the movement of the mounting block 420 along the X-axis. The allowed movements of the respective mounting blocks 420 may enable self-alignment of the mounting blocks 420 and the connector terminals of the cables 140 connected to them directly or via one or more adaptors, with respect to ports of various subject devices 130. This feature may accommodate positional deviations in the ports of various subject devices 130. The independently movable mounting blocks 420 may allow the connector terminals of cables 140 (or the connector terminal of an adaptor receiving a cable 140) to self-align or be adjustably positioned, facilitating connection with the ports of respective subject devices 130, even in the presence of positional deviations.

The side wall 418-1 may include holes 440 (individually identified as a first hold 440-1, a second hole 440-2, a third hole 440-3, and a fourth hole 440-4) where the depth rod 470B is supported. A bias component 480B (individually identified as a first bias component 480A-1, a second bias component 480A-2, a third bias component 480A-3, and a fourth bias component 480A-4) may also be supported on the depth rod 470B to allow a movement of the mounting block 420 along the Y-axis. Respective mounting blocks 420 may move along the Y-axis on the depth rod 470B independently to each other. The hole 440 may be sized to allow a movement of the mounting block 420 along the X-axis. In some embodiments, the mounting block 420 may move along both the X-axis and the Y-axis.

In some embodiments, the mounting block 420 may be configured to move along the Z-axis. For example, the mounting block 420 and a bias component 480 may be supported on a vertical rod so that the mounting block 420 may move along the Z-axis.

The mounting block 420 may include an adaptor 490 placed at least partially within the casing 450 (individually identified as a first adaptor 490-1 located within the first casing 450-1, a second adaptor 490-2 located within the second casing 450-2, a third adaptor 490-3 located within the third casing 450-3, and a fourth adaptor 490-4 located within the fourth casing 450-4). The adaptor 490 may be shaped to secure a cable 140 (e.g., a connector of the cable 140) in position. The adaptor 490 may be replaceable such that different cables may be secured in a same mounting block 420. The casing 450 may have an aperture 455 (individually identified as a first aperture 455-1 on the first casing 450-1, a second aperture 455-2 on the second casing 450-2, a third aperture 455-3 on the third casing 450-3, and a fourth aperture 455-4 on the fourth casing 450-4). A cable 140 (e.g., a connector of the cable 140) held by the adaptor 490 may be connected to a port of the subject device 130 via the aperture 455.

For example, a mounting block 420 may be configured to replaceably house a first adapter configured to secure a first connector of a first cable in position (when the connector system 120 is used to connect with a first device with a first port configuration) and a second adapter configured to secure a second connector of a second cable in position (when the connector system 120 is used to connect with a second device with a second port configuration that is different from the first port configuration).

As another example, the first mounting block 420-1, the second mounting block 420-2, and the third mounting block 420-3 of the connector system 120 may be configured to replaceably house a first adapter, a second adaptor, and a third adaptor, respectively, while the fourth mounting block 420-4 of the connector system 120 may lack an adaptor and hold no cable, when the connector system 120 is used to connect with a first device with a first port configuration having three ports; the first mounting block 420-1 and the fourth mounting block 420-4 of the connector system 120 may be configured to replaceably house a first adapter and a fourth adaptor, respectively, while the second and the third mounting blocks 420-2 and 420-3 of the connector system 120 may each lack an adaptor and hold no cable, when the connector system 120 is used to connect with a second device with a second port configuration having two ports.

In some embodiments, the count of the mounting blocks may be different from the count of the set of ports of a device to be connected with the connector system 120. The connector system 120 may be configured to operably connect with a first device via a first subset of the mounting blocks and with a second device via a second subset of the mounting blocks that are different from (e.g., no overlapping or partially overlapping) the first subset.

The mounting system 150 may include a stationary portion 152, a guide 154 fixedly attached to the stationary portion 152, and a movable portion 156 movably coupled to the guide 154. The subject device 130 may be removably mounted on (for testing) and removed from (after testing) a stationary portion 152, while the connector system 120 may be mounted on the movable portion 156. The mounting and/or removal of the subject device 130 may be performed manually by a user, or automatically by, e.g., the robotic arm 170. The movable portion 156 may move toward or away from the stationary portion 152 by, e.g., sliding on the guide 154 along the Z-axis. A movement of the movable portion 156 along the Z-axis may be achieved manually by a user pushing or pulling the movable portion 156, e.g., via a handle 158 attached to the movable portion 156. The movement of the movable portion 156 along the Z-axis may be achieved automatically by an actuator or using the robotic arm 170. Although one robotic arm 170 is illustrated in FIG. 1, the testing system 100 may include more than one robotic arm, e.g., one for maneuvering (e.g., setting up) the subject device 130 and a different one for operating the movable portion 156.

The control system 160 may control at least a portion of the actions involved in the process in the testing system 100. For example, the control system 160 may control the operation of the actuator or the robotic arm 170 for moving the movable portion 156. As another example, the control system 160 may control an automated operation of mounting or removing the subject device 130 from the stationary portion 152. As a further example, the control system 160 may control the testing of the subject device 130 by the test device 110.

The control system 160 may include memory and one or more processors. Memory can store instructions for running one or more applications or modules on the one or more processors. For example, the memory may be used in one or more embodiments to house all or some of the instructions needed to implement the functionality of sensor data retrieval, communications with other components of the testing system 100 (e.g., the robotic arm 170, sensors configured to monitor operation related information, control command generation, etc.); processor(s) may be used to execute the instructions to implement the implement the functionality of sensor data retrieval, communications, control command generation, etc.

In some embodiments, the memory of the control system 160 can include any device, mechanism, or populated data structure used for storing information. In accordance with some embodiments of the present disclosures, memory can encompass, but is not limited to, any type of volatile memory, nonvolatile memory, and dynamic memory. For example, the memory can be random access memory, memory storage devices, optical memory devices, magnetic media, floppy disks, magnetic tapes, hard drives, SIMMs, SDRAM, RDRAM, DDR, RAM, SODIMMs, EPROMs, EEPROMs, compact discs, DVDs, and/or the like. In accordance with some embodiments, memory may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory. In some example aspects, memory may store at least one database containing the customizable features of the networks, a prioritized order of the networks, or user requested content information, such as audio or video data.

The processor(s) of the control system 160 may include one or more programmable processors executing one or more computer programs to perform functions by operating on input data and generating output. The processor(s) may also be implemented as, special purpose logic circuitry, e.g., an FPGA (field programmable gate array) or an ASIC (application specific integrated circuit). The processor(s) may include both general and special purpose microprocessors, and any one or more processors of any kind of digital computer. Merely by way of example, the control system 160 may include a programmable logic controller (PLC) or a similar programmable controller. This unit may process input data from the sensors and execute predefined control algorithms to adjust the testing operation. The PLC may allow for precise control over the testing system 100, ensuring that it responds appropriately to varying operation conditions including, e.g., load conditions.

The control system 160 may communicate with one or more components of the testing system 100 via a wired or a wireless communication path. Examples of such communication paths may include the Internet, a mobile phone network, a mobile voice or data network (e.g., a 5G or Long Term Evolution (LTE) network), a cable network, a public switched telephone network, a short-range wireless communication network (e.g., Bluetooth or Near Field Communications (NFC)), or other types of communications networks or combinations of communications networks. The communication paths may separately or together include one or more communications paths, such as a satellite path, a fiber-optic path, a cable path, a path that supports Internet communications (e.g., Internet Protocol television (IPTV)), free-space connections (e.g., for broadcast or other wireless signals), or any other suitable wired or wireless communications path or combination of such paths. The control system 160 may include additional communication paths linking a plurality of hardware, software, and/or firmware components operating together. For example, the control system 160 may be implemented by a cloud of computing platforms operating together as the control system 160.

As another example, the control system 160 may be connected to or integrated with, via one or more such communication paths, a network of sensors, or broader warehouse or factory management software, allowing for automated operation based on the overall workflow. This integration can optimize the use of the testing system 100 as part of a larger operation.

The control system 160 may incorporate one or more safety mechanisms including, e.g., emergency stop buttons, overload alerts, and automatic shutdown protocols in case of malfunctions or excessive strain on the testing system 100.

The testing system 100 may include or communicate with one or more sensors to achieve efficient, safe, and effective functioning. Example sensors include a speed sensor configured to measure the speed of the movable portion 156 (or the connector system 120 attached thereon) moving toward or away from the stationary portion 152 (or the subject device 130 attached thereon), a proximity sensor configured to detect the distance between the connector system 120 and the subject device 130, a temperature sensor configured to monitor the temperature of one or more components like motors and bearings of the testing system 100, a vibration sensor configured to detect unusual vibrations in the testing system 100, an optical sensor (e.g., a photoelectric sensor) configured for various purposes (e.g., monitoring a proper placement of the subject device 130 and/or the connector system 120 for testing), an emergency stop sensor (e.g., a button-based sensor) configured to allow for the immediate shutdown of the testing system in case of an emergency, a radio-frequency identification (RFID) sensor configured to identify the subject device 130 (e.g., providing data for inventory management and process control), etc.

The testing system 100 may include a user interface (UI), e.g., with a control panel, where operators can monitor the status of the testing system 100, input operational parameters, and override automatic controls if needed. This interface may a manual control over the system and for troubleshooting. The UI may serve as the bridge between a user and the technical processes of the testing system 100. The UI may include a graphical user interface (GUI).

For example, the UI may feature a dashboard that provides a comprehensive overview of the testing system 100's current status including, e.g., real-time data on the operation of the robotic arm 170. The UI may have a dedicated section for controlling and adjusting the motor speed. This may be implemented through a slider or input field where the user can set a specific speed or choose from pre-defined speed settings optimized for different load types. The UI may include an interface element for monitoring and adjusting the operation of a component of the testing system 100. The UI may also display a recommended operation or adjustment thereof. The UI may include a UI element configured to allow a user to manually adjust or set parameters including, e.g., manual override options for situations where specific settings are needed. The UI may present data from various sensors, such as optical sensors, proximity sensors, etc. This data may help the user understand the current operating conditions of the testing system 100 to make informed decisions. The UI may provide access to historical data and logs, detailing past operations, changes made, and any alerts or issues that have arisen. This may assist the user for troubleshooting and understanding the long-term performance of the testing system 100. The UI may feature an alert system, notifying the user of any issues, such as malfunctions, excessive load, overheating, mismatch between a port configuration of a subject device and a set of cables secured in the connector system 120, a test result of a subject device, deviations from optimal operating conditions, or the like, or a combination thereof. This ensures immediate attention to any potential problems. The UI may have an UI element for help and support, providing users with guidance on how to operate the testing system 100, troubleshoot issues, and understand the readings and controls. Users may be able to customize certain aspects of the UI, such as display settings, notification preferences, and control panel layouts, to suit their individual needs and preferences. The UI may include quick-access buttons for emergency stops and other safety protocols, ensuring that users can quickly respond to any hazardous situations. The testing system 100 may offer remote access capabilities, allowing users to monitor and control the testing system 100 from different locations. Additionally, the UI may integrate with other systems in the facility for coordinated operations.

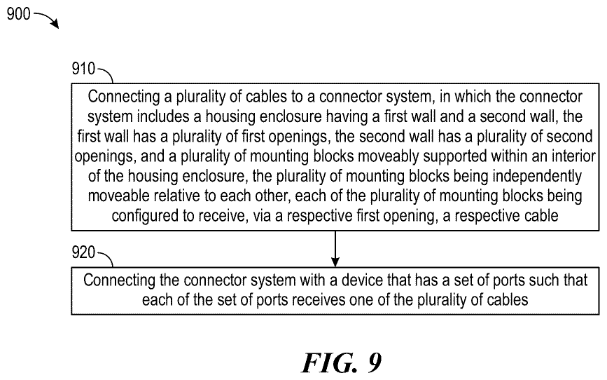

FIG. 9 is a flowchart for a method of using a connector system in accordance with some embodiments of the present disclosure. The process 900 may include at 910 connecting a plurality of cables to the connector system 120 as disclosed herein, and at 920 connecting the connector system 120 with the subject device 130 that has a set of ports such that each of the set of ports receives one of the plurality of cables. Connecting the connector system with the device may be achieved by a single action that simultaneously connects the respective cables to the set of ports of the device. The process 900 may further include connecting the connector system 120 with a second device that has a set of second ports such that each of the set of second ports receives one of the plurality of cables, in which the set of second ports of the second device are different from the set of ports of the device. For example, the difference may be that the two sets of ports are of the same port types arranged in a same order, but there are positional deviations between the corresponding ports in the two devices. As another example, the difference may be that the two sets of ports are of the same port types arranged in different orders. As a further example, the difference may be that the two sets of ports include ports of different types. Connecting the connector system with the second device may include allowing at least one of the plurality of mounting blocks to move relative to when the connector system 120 is connected to the device, and/or changing adaptors housed in one or more of the mounting blocks of the connector system 120.

Some embodiments may implement one or more of the following solutions, listed in clause-format. The following clauses are supported and further described in the embodiments above and throughout this document.

1. A connector system, including: a housing enclosure having a first wall and a second wall, the first wall having a first opening and a second opening; and a plurality of mounting blocks movably supported within an interior of the housing enclosure, the plurality of mounting blocks being independently movable relative to each other, and each of the plurality of mounting blocks being configured to receive, via the first opening, a cable with a connector. The connector system is configured to operably connect, via the second opening, the respective cables to a device that has a set of ports configured to receive connectors of the respective cables. In some embodiments, the housing enclosure may include multiple portions configured to be connectable and separable. For example, the housing enclosure may comprise a base component and a retaining cover. The base component and the retaining cover may be connected to form the interior of the housing enclosure for housing one or more mounting blocks, and separated to allow access to the interior of the housing enclosure to, e.g., position or remove (e.g., replace) one or more mounting blocks from the interior of the housing enclosure.

2. The connector system of one or more solutions disclosed herein, in which the connector system is configured to simultaneously connect, by a single action, the respective cables with the ports of the device.

3. The connector system of one or more solutions disclosed herein, in which a respective mounting block is coupled to a set of bias components configured to allow the respective mounting block to move in one or more directions.

4. The connector system of one or more solutions disclosed herein, in which the set of bias components includes a spring.

5. The connector system of one or more solutions disclosed herein, further including a plurality of rods fixedly supported on the housing enclosure and configured to movably support the respective mounting blocks and the sets of bias components.

6. The connector system of one or more solutions disclosed herein, in which the plurality of rods include a set of first rods, and a respective mounting block is movably supported on a respective first rod and configured to move along a first direction.

7. The connector system of one or more solutions disclosed herein, in which at least one of the set of bias components is movably supported on a same first rod as the mounting block to allow the mounting block to move along the first direction.

8. The connector system of one or more solutions disclosed herein, in which the second opening is sized to accommodate a movement of a respective mounting block along the first direction.

9. The connector system of one or more solutions disclosed herein, in which the plurality of rods further include a set of second rods, and a respective mounting block is movably supported further on a respective second rod and configured to move along a second direction that is different from the first direction.

10. The connector system of one or more solutions disclosed herein, in which at least one of the set of bias components is movably supported on a same second rod as the mounting block to allow the mounting block to move along the second direction.

11. The connector system of one or more solutions disclosed herein, in which the second opening is sized to accommodate a movement of a respective mounting block along the second direction.

12. The connector system of one or more solutions disclosed herein, in which a respective mounting block is coupled to a first bias component supported on a first rod and a second bias component supported on a second rod such that the mounting block is movable in both the first direction and the second direction.

13. The connector system of one or more solutions disclosed herein, in which a respective mounting block is configured to replaceably house a first adapter configured to secure a first connector of a first cable in position and a second adapter configured to secure a second connector of a second cable in position.

14. The connector system of one or more solutions disclosed herein, in which the connector system is configured to operably connect the respective cables to a second device that has a set of second ports of same types as the device.

15. The connector system of one or more solutions disclosed herein, in which the set of second ports of the second device are arranged differently than the set of ports of the device.

16. The connector system of one or more solutions disclosed herein, in which at least one of the plurality of mounting blocks is configured to move when the connector system is connected to the second device relative to when the connector system is connected to the device.

17. The connector system of one or more solutions disclosed herein, in which the connector system is configured to operably connect the respective cables to a second device that has a set of second ports, at least one of the set of second ports being of a different type than the set of ports of the device.

18. The connector system of one or more solutions disclosed herein, further including at least one status indicator configured to indicate whether the respective cables are operably connected to the ports of the device.

19. The connector system of one or more solutions disclosed herein, in which the first wall opposes the second wall.

20. The connector system of one or more solutions disclosed herein, in which a count of the mounting blocks is different from a count of the set of ports of the device.

21. The connector system of one or more solutions disclosed herein, in which the connector system is configured to operably connect with the device via a first subset of the mounting blocks and with a second device via a second subset of the mounting blocks, the first subset being different from or partially overlapping the second subset.

22. A method, including: connecting a plurality of cables to a connector system of any one or more of the solutions disclosed herein; and connecting the connector system with a device that has a set of ports such that each of the set of ports receives one of the plurality of cables.

23. The method of one or more solutions disclosed herein, in which connecting the connector system with the device includes a single action that simultaneously connects the respective cables to the set of ports of the device.

24. The method of one or more solutions disclosed herein, further including: connecting the connector system with a second device that has a set of second ports such that each of the set of second ports receives one of the plurality of cables, in which the set of second ports of the second device are different from the set of ports of the device.

25. The method of one or more solutions disclosed herein, in which connecting the connector system with the second device includes: allowing at least one of the plurality of mounting blocks to move relative to when the connector system is connected to the device.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present technology have been shown and described, it will be obvious to those skilled in the art that, based upon the teachings herein, changes and modifications may be made without departing from this technology and its broader aspects and, therefore, the appended claims are to encompass within their scope all such changes and modifications as are within the true spirit and scope of this technology. Furthermore, it is to be understood that the technology is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to technologies containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood with the context as used in general to present that an item, term, etc., may be either A or B or C, any nonempty subset of the set of A and B and C, or any set not contradicted by context or otherwise excluded that contains at least one A, at least one B, or at least one C. For example, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B, and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and the alternate aspects falling within the spirit of the broader aspects of the general inventive concept embodied in this application that do not depart from the broader scope of the claimed disclosure.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A connector system, comprising:
a housing enclosure having a first wall and a second wall, the first wall having a first opening, the second wall having a second opening; and
a plurality of mounting blocks movably supported within an interior of the housing enclosure, the plurality of mounting blocks being independently movable relative to each other, and each of the plurality of mounting blocks being configured to receive, via the first opening, a cable with a connector, wherein:
the connector system is configured to operably connect, via the second opening, the respective cables to a device that has a set of ports configured to receive connectors of the respective cables.

2. The connector system of claim 1, wherein the connector system is configured to simultaneously connect, by a single action, the respective cables with the ports of the device.

3. The connector system of claim 1, wherein a respective mounting block is coupled to a set of bias components configured to allow the respective mounting block to move in one or more directions.

4. The connector system of claim 3, wherein the set of bias components comprises a spring.

5. The connector system of claim 3, further comprising a plurality of rods fixedly supported on the housing enclosure and configured to movably support the respective mounting blocks and the sets of bias components.

6. The connector system of claim 5, wherein
the plurality of rods comprise a set of first rods, and
a respective mounting block is movably supported on a respective first rod and configured to move along a first direction.

7. The connector system of claim 6, wherein at least one of the set of bias components is movably supported on a same first rod as the mounting block to allow the mounting block to move along the first direction.

8. The connector system of claim 6, wherein the second opening is sized to accommodate a movement of a respective mounting block along the first direction.

9. The connector system of claim 6, wherein
the plurality of rods further comprise a set of second rods, and
a respective mounting block is movably supported further on a respective second rod and configured to move along a second direction that is different from the first direction.

10. The connector system of claim 9, wherein at least one of the set of bias components is movably supported on a same second rod as the mounting block to allow the mounting block to move along the second direction.

11. The connector system of claim 9, wherein the second opening is sized to accommodate a movement of a respective mounting block along the second direction.

12. The connector system of claim 9, wherein a respective mounting block is coupled to a first bias component supported on a first rod and a second bias component supported on a second rod such that the mounting block is movable in both the first direction and the second direction.

13. The connector system of claim 1, wherein a respective mounting block is configured to replaceably house a first adapter configured to secure a first connector of a first cable in position and a second adapter configured to secure a second connector of a second cable in position.

14. The connector system of claim 1, wherein the set of second ports of the second device are arranged differently than the set of ports of the device.

15. The connector system of claim 14, wherein at least one of the plurality of mounting blocks is configured to move when the connector system is connected to the second device relative to when the connector system is connected to the device.

16. The connector system of claim 1, wherein the connector system is configured to operably connect the respective cables to a second device that has a set of second ports, at least one of the set of second ports being of a different type than the set of ports of the device.

17. A method, comprising:
connecting a plurality of cables to a connector system, wherein the connector system comprises:
a housing enclosure having a first wall and a second wall, the first wall has a plurality of first openings, the second wall has a plurality of second openings;
a plurality of mounting blocks movably supported within an interior of the housing enclosure, the plurality of mounting blocks being independently movable relative to each other, each of the plurality of mounting blocks being configured to receive, via a respective first opening, a respective cable; and
connecting the connector system with a device that has a set of ports such that each of the set of ports receives one of the plurality of cables.

18. The method of claim 17, wherein connecting the connector system with the device comprises a single action that simultaneously connects the respective cables to the set of ports of the device.

19. The method of claim 17, further comprising:
connecting the connector system with a second device that has a set of second ports such that each of the set of second ports receives one of the plurality of cables, wherein the set of second ports of the second device are different from the set of ports of the device.

20. The method of claim 19, wherein connecting the connector system with the second device comprises:
allowing at least one of the plurality of mounting blocks to move relative to when the connector system is connected to the device.
